(19) United States
(12) Patent Application Publication
(10) Pub. No.: US 2013/0020029 A1
(43) Pub. Date: Jan. 24, 2013

(54) MULTIPLE MASKING TAPE APPLICATOR HAND TOOL AND METHOD

(71) Applicant: Ioan Lazar, Renton, WA (US)

(72) Inventor: Ioan Lazar, Renton, WA (US)

(21) Appl. No.: 13/556,068

(22) Filed: Jul. 23, 2012

Related U.S. Application Data
(60) Provisional application No. 61/510,721, filed on Jul. 22, 2011.

(51) Int. Cl. B32B 38/18

(52) U.S. Cl. 156/527

(57) ABSTRACT

A hand tool used to mask and cover a large area when painting that dispenses unwound sections of two rolls of masking tape in a side-by-side manner on a desired wall with their adhesive surfaces oriented in opposite directions. The hand tool includes two spools horizontally spaced apart and attached to a rigid support plate. Attached to the support plate is a rotating alignment rod and a rotating tensioning rod that the unwound sections of tape travel across. The adhesive surface on the first roll is pressed against the desired surface. The tool is then pulled across the surface causing both rolls to simultaneously unwind. When the desired amount of tape has been dispense, a cutting edge on the hand tool is used to cut the two unwound sections of tape. The adhesive surface on the second roll is exposed and a large masking sheet may attached thereto.

This utility patent application is based upon and claims the filing date benefit of U.S. provisional patent application (Application No. 61/510,721), filed on Jul. 22, 2011.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention pertains to hand tools used for masking a surface and more particularly, to hand tools used to efficiently applying multiple layers of masking tape to a protected surface that will also be at least partially covered by a large sheet of masking paper or plastic.

2. Description of the Related Art

It is well known that masking is an important task for protecting non-painted edges and surfaces when painting. For example, when painting a wall 200 as shown in FIG. 1 that includes a window opening 202 or a door opening 206, it is important to protect the decorative moldings 204, 208, respectively, installed around the two openings and the window glass 205 and door 209.

As shown in FIGS. 2 and 3, a strip of pressure sensitive masking tape 220 made of paper with a low residue generating adhesive applied to one surface, is commonly used along the decorative moldings 204, 208 to be protected. Painters typically use a special type of masking tape, called ‘painter's tape’ that has a moderately strong, low residue producing adhesive that adheres evenly and smoothly over the an edge or surface for a few hours. Painter's tape is characteristically blue or purple in color and visually distinguishable from household or draftsman masking tape that are normally beige or light tan in color. During the installation process, it is important that sufficient force be applied to the strip of painter's tape so that no folds or bubbles are formed that may allow paint does not seep under the painting tape.

To prevent overspray to a large area on a wall 200, such as the window glass 205 or door 209 a strip of painter's tape 220 is applied around the perimeter edges of the large area and a large sheet 230 of lightweight paper or plastic is selected that extends across and covers the window glass 205 and door 209. In some instances, a second strip of masking tape 225 is applied to the perimeter edges of the large sheet 230 that holds the large sheet 230 over the stripe of painter's tape and holds the large sheet 230 over the window glass and door.

Unfortunately, evenly applying a first strip of painter's tape 220 to a wall surface or to a decorative edge and then applying a second layer of masking tape 225 to the perimeter edge of a large sheet 230 and then evenly applying the exposed adhesive layer on the second strip of masking tape 225 over the first strip of painter's tape 220 is very time consuming.

### SUMMARY OF THE INVENTION

It is an object of the present invention to provide a hand tool that enables a worker to more efficiently apply a first strip of masking tape with its adhesive surface pressed against a flat surface to be protected when painting and simultaneously apply a second strip of masking tape adjacent to and partially attached to the first strip of masking tape which its adhesive surface facing in the direction opposite the adhesive surface of the first strip of masking tape so that a large sheet of lightweight masking paper or plastic may be attached to the adhesive layer on the second strip of masking tape to cover large area adjacent to the first strip of masking tape.

Disclosed herein is a hand tool that includes two, freely rotating first and second spools perpendicularly mounted in an fore to aft offset position on one side of a flat, rigid support plate. The two spools are parallel and perpendicularly aligned to the support plate and each spool is designed to hold a single roll of regular or painter's masking tape, hereinafter referred to a first roll and a second roll, respectively. In a first embodiment, the two spools are slightly offset from the front surface of the support plate, so that when the first and second rolls of tape are unwound, the unwound section of tape from the first spool is located adjacent to the support plate and the unwound section of tape from the second spool is parallel to and partially overlaps to the unwound section of tape from the first roll. The first and second rolls are positioned on the two spools so that their adhesive surfaces are oriented in opposite directions so that the overlapping portions of the two tapes are adhesively attached together when pressed together.

Located above and between the two spools is a free spinning rotating alignment rod. Located slightly above and adjacent to the alignment rod is a rotating tensioning rod. During assembly, the adjacent unwound sections of the first and second rolls of tape extend around the alignment rod and attached. The two unwound sections of tape then extend upward and around the tensioning rod. Located above the tensioning rod is a cutting edge designed to cut the two unwound sections.

After assembly, the hand tool is held so that the support plate is parallel to the desired flat surface. The adhesive surface on the end of the unwound section of tape on the first roll is pressed against the desired location on the wall or flat surface. When the hand tool is pulled across the flat surface, the two unwound sections of tape from the first and second rolls are simultaneously pulled over the rotating tensioning and alignment rods. When the adhesive surface on the first roll is forced against the desired flat surface, sufficient dragging pressure is applied to the hand tool so that unwound sections of tape are under tension and taunt. Because the two unwound sections of tape are first aligned and pressed together over the alignment rod, the two unwound sections are attached together and remain parallel and evenly and uniformly aligned at all times. When the desired amount of unwound sections of tape from the two rolls have been applied to the flat surface, hand tool is then repositioned so that the cutting edge may be forced against the unwound sections and cut them.

After the two sections of tape from the first and second rolls have been cut to size and applied to the flat surface, the adhesive surface on the unwound section of tape from the second roll is exposed. A large, lightweight sheet of masking paper or plastic is then applied to the exposed adhesive surface on the unwound section of tape from the second roll. The large sheet is then unfolded and extended across the entire large area.

In a second embodiment, a third spool with a third roll of masking tape attached thereto is coaxially aligned with and attached over the first spool. During operation, the third roll of tape attached to the third spool is simultaneously dispensed with the first roll of tape on the first spool. Like the first embodiment, the first and second rolls of tape are oriented so that their adhesive surfaces face in the opposite directions. In the second embodiment, the third roll of tape is oriented with its adhesive surface in the same direction as the first roll of tape. The third spool is coaxially aligned with the first spool. The third spool is located outside the second spool and offset from the second spool so that the unwound section of tape from the third roll is parallel and slightly offset from the unwound section of tape from the second roll. The third spool is positioned and the width of the third roll of tape is sufficient so that the center portion of the unwound section of tape from the second roll is continuously exposed. Because the three unwound sections of tape are first aligned and pressed together over the alignment rod, the three unwound sections are attached together and remain parallel and evenly and uniformly aligned at all times.

The second embodiment is useful when a single strip of unwound section of the first roll of tape is insufficient to hold a large sheet to a flat surface. Using a third roll of tape provides more adhesive surface contact but also hold the opposite edge of the unwound second of the second roll of tape in place. Typically, the second embodiment is useful when the wall surface is exposed to moisture, has a rough texture, or when a heavier large sheet is used.

### DESCRIPTION OF THE DRAWINGS

FIG. 1 is an illustration of the prior art showing the front elevational view of a wall to be painted with a window and a door opening formed therein.

FIG. 2 is a front elevational view of the wall in the prior art shown in FIG. 1 with dual layers of masking tape and a large piece of masking material placed inside the window and door opening.

FIG. 3 is a sectional side elevational view of the wall in the prior art taken along line 3-3 in FIG. 2.

FIG. 4 is a front elevational view of the first embodiment of the multiple tape hand tool designed to simultaneously dispensed two parallel strips of masking tape with their adhesive surfaces oriented in opposite directions.

FIG. 5 is a right side elevational view of the hand tool shown in FIG. 4.

FIG. 6 is a left side elevational view of the hand tool shown in FIGS. 4 and 5.

FIG. 7 is a top plan view of the hand tool shown in FIGS. 4-5.

FIG. 8 is a front elevational view of a second embodiment of the hand tool designed to simultaneously dispensed two or three parallel strips of masking tape.

FIG. 9 is an exploded perspective view of the second embodiment of the hand tool shown in FIG. 8 being assembled to dispense three strips of tape by coaxially aligning and attaching a third spool over the first spool.

FIG. 10 is right side elevational view of the embodiment of the hand tool shown in FIG. 9 showing the third roll of tape being aligned over a third spool showing the third spool be coaxially aligned over a coupler that attaches to the first spool.

FIG. 11 is a partial side elevational view of the third and first spools in the assembled position with the third and first roll of tape spaced apart to form a gap.

FIG. 12 is a partial side elevational view of coupler being attached to the first spool.

FIG. 13 is a partial, sectional, side elevational view of the lower lip on the extension arm on the coupler extending into the slot formed on the first spool that holds the coupler on the first spool.

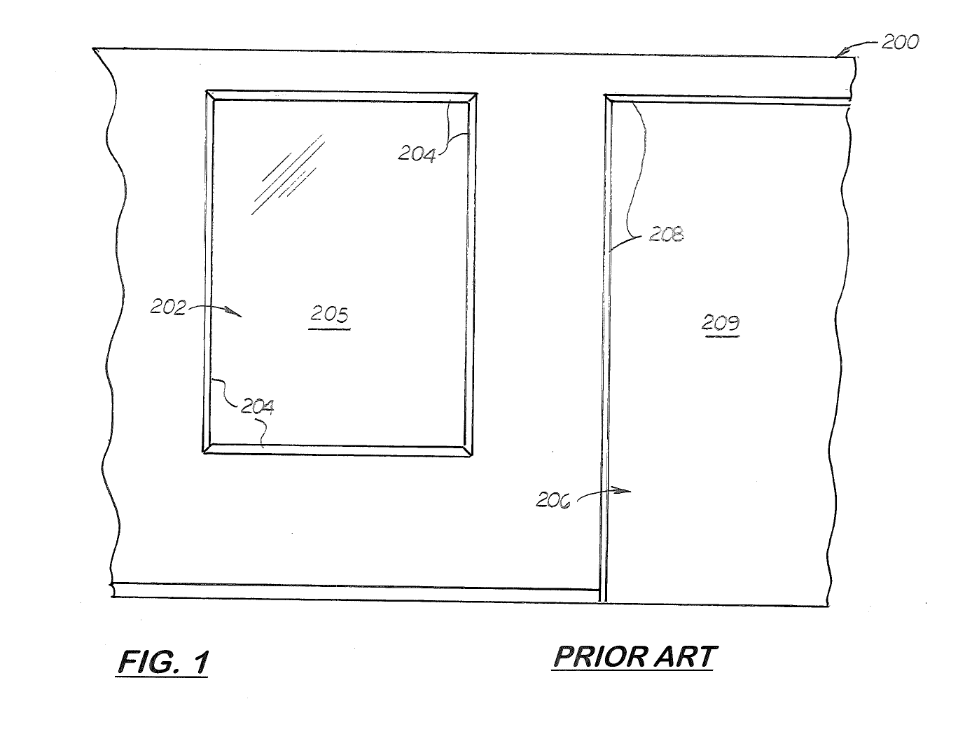

### DESCRIPTION OF THE PREFERRED EMBODIMENT(S)

Referring to the accompanying Figs. there is shown a hand tool 10 that includes two, freely rotating first and second spools 30, 40 mounted in a parallel configuration on the front surface 13 on a rigid support plate 12. The support plate 12 includes an upper arm 14 integrally attached or formed on a lower body 16. Attached to the lower body 16 is a handle 20 and an optional belt clip 22.

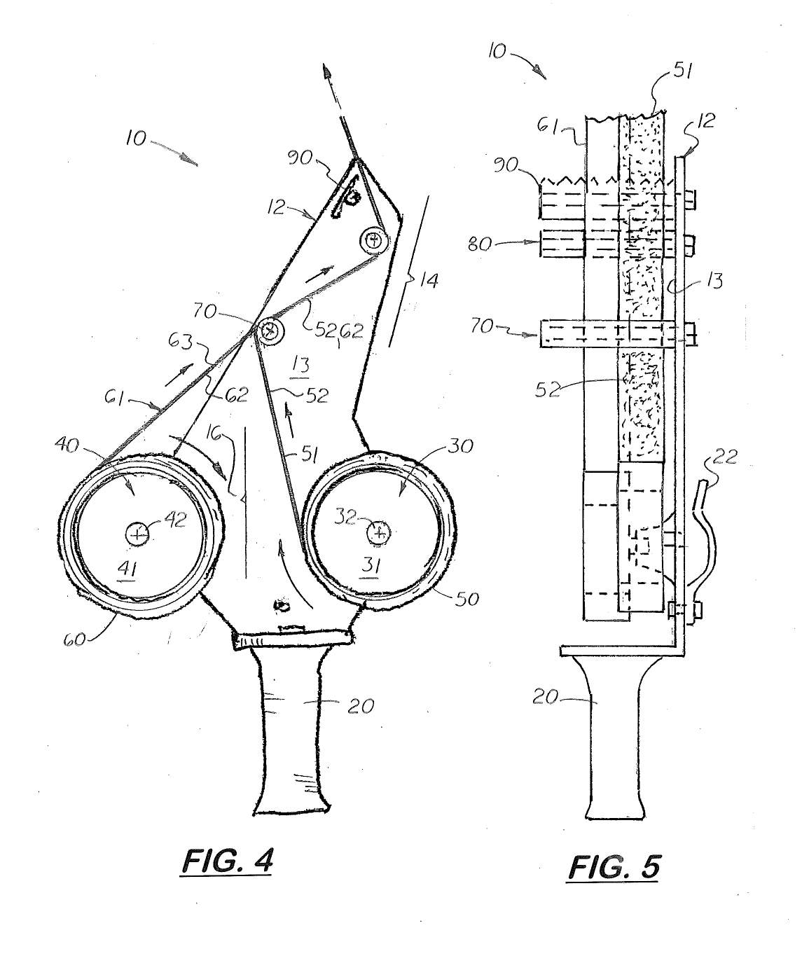

As shown in FIG. 4, the two spools 30, 40 extend perpendicular outward from the front surface 13 of the support plate 12. The two spools 30, 40 each include a cylindrical body 31, 41 mounted on an axle 32, 42, respectively. A suitable connector, such as a press washer or a threaded connector is used to hold the cylindrical body 31, 41, in place on the axle 32, 42, respectively. In the embodiment shown in the Figs, the cylindrical bodies 31, 41 are approximately 3 inches in diameter and 1-¼ in length.

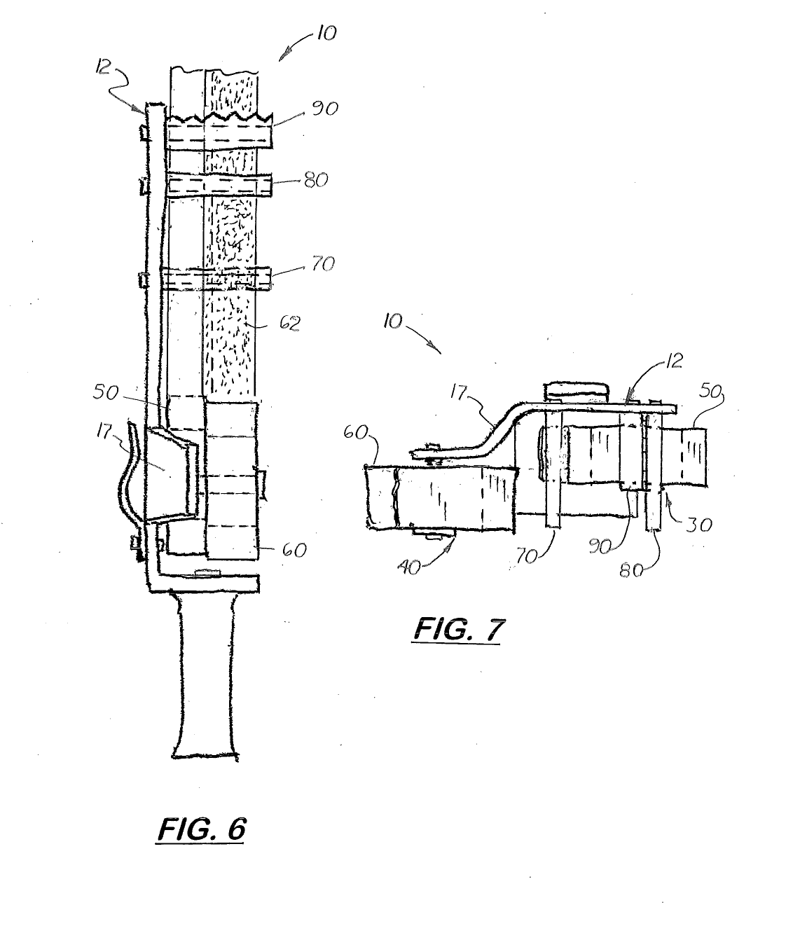

The spools 30, 40 are horizontally aligned and spaced three to four inches apart and at or near the same elevation on the support plate 12. As shown more clearly in FIGS. 6 and 7, the center section 17 of the support plate 12 extends outward thereby positioning the second spool outward from the first spool 30.

As stated above, attached to the upper arm 14 of the support plate 12 and above the first spool 30 and approximately equal distance from each spool 30, 40 is a free rotating alignment rod 70. In the embodiment shown, the alignment rod 70 is perpendicularly aligned to the support plate's front surface 13 and fixed. The alignment rod 70 includes a threaded end that engages a threaded bore formed on the support plate 12. Aligned parallel with and located slightly below and lateral to the alignment rod 70 is a perpendicularly aligned tensioning rod 80. Like the alignment rod 70, the tensioning rod 80 are freely rotating with a distal end that is inserted into a smooth bore formed on the support plate 12. Suitable connectors are used hold the distal ends of the alignment and tensioning rods on the support plate 12.

During assembly, the two spools 30, 40 are aligned on the support plate 12 so that when the two rolls of masking tape 50, 60 are aligned on the two spools 30, 40, respectively, their adhesive surfaces face 52, 62 facing opposite directions. When the two unwound sections 51, 61 from the rolls 50, 60, respectively, are partially overlapped, the two unwound sections 51, 61 are adhesively joined together.

When the first and second rolls 50, 60 are installed on the two spools 30, 40, respectively, the unwound sections of tape 51, 61 extend upward and converge around the top surface of an alignment rod 70 and then continue upward around the tensioning rod 80. As shown in FIG. 5, the center section 17 of the support plate 13 is bent forward thereby positioning the two spools 30, 40 at different distances from the front surface 13 of the support plate 12 which allow the unwound sections of tape 51, 61 from the rolls 50, 60, respectively, to be parallel and slightly offset so that they overlap over their adjacent edges. Also as the rolls 50, 60 unwind, the adhesive surface 52 on the unwound section 51 of tape from the first roll 50 is pressed against the adhesive surface 62 on the unwound section of tape 61 from the second roll 60 thereby adhesively connecting the unwound sections of tape 51, 61 from the two rolls 50, 60 together.

During assembly, the unwound sections of tape 51, 61 are unwound from the two rolls 50, 60, respectively, and extended over the alignment rod 70. The two unwound sections of tape 51, 61 are pulled around on over the tensioning rod 80 and upward towards a cutting blade 90. As the unwound sections of tape 51, 61 from the two rolls 50, 60, respectively, are wrapped around the alignment rod 70 and the tensioning rod 80, they are forced together. Because the alignment rod 70 and tensioning rod 80 rotate, the adhesive surfaces on the unwound sections easily roll over them.

As discussed above, attached to the lower portion of the support plate 12 is a vertically or diagonally aligned rigid handle 20 that allows a user to hold the support plate 12 is position substantially parallel to a flat surface to be masked. Also, attached to the back surface of the support plate 12 is an optional belt clip 22.

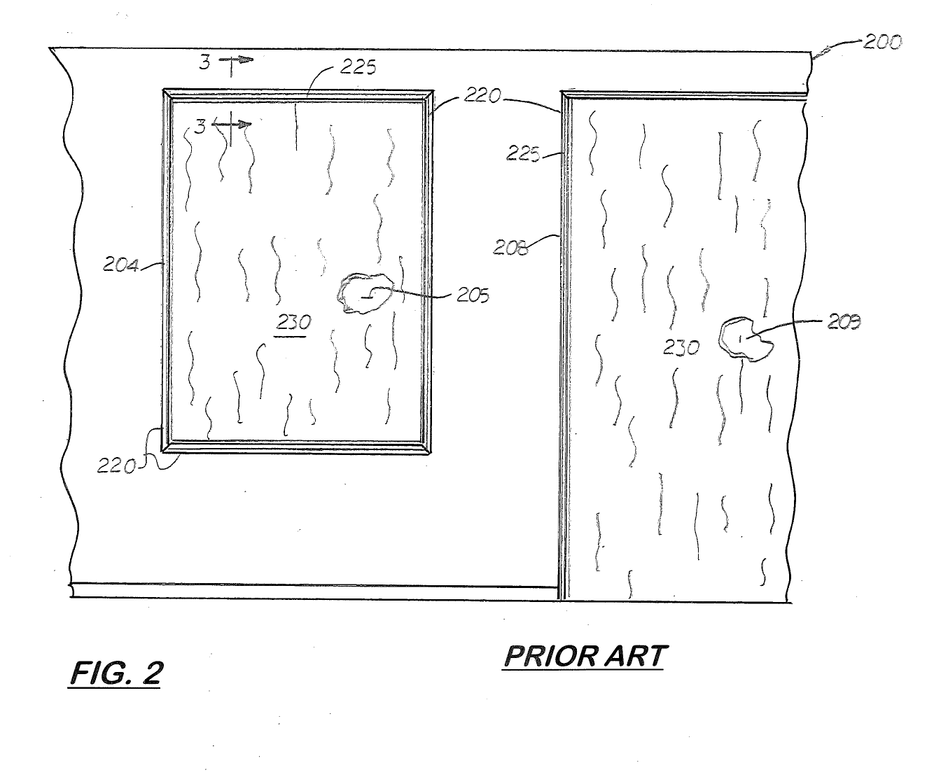

The hand tool 10 is held against the surface to be protected so that the adhesive surface 52 of the unwound section 51 of tape from the first roll 50 is exposed and may be pressed against a flat surface to be masked. The exposed adhesive surface 62 on the unwound section of tape 61 from the second roll 60 faces outward and acts as an attachment surface for a large piece of masking material 230 used to cover a large area, such as a window opening 200 or door opening 300 as shown in FIG. 2.

After the two unwound sections of tape 51, 61 from the two rolls 50, 60 have been cut to size and applied to the flat surface, the adhesive surface 62 on the unwound section 61 of tape from the second roll 60 is exposed. The perimeter edge of a large sheet of masking paper or plastic 230 is then applied to the exposed adhesive surface 62 to hold the large sheet 230 in place of the flat surface. The large sheet 230 is then unfolded and extended across the entire large area and attaches to the exposed adhesive surface 62 on a tape 60 attached thereto.

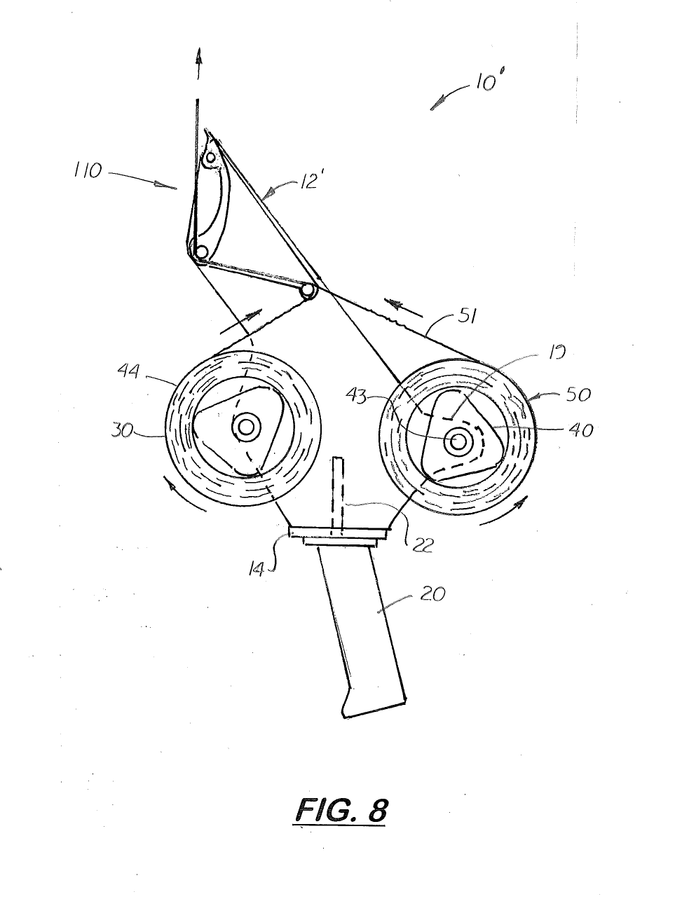

FIG. 8 is a front elevational view of a second embodiment of the hand tool designed to simultaneously dispensed two or three parallel strips of masking tape. In a second embodiment of the hand tool, denoted at 10′, a third spool 44 with a third roll of masking tape 65 attached thereto is coaxially aligned with and attached over the first spool 30. During operation, the third roll of tape 65 attached to the third spool 44 is simultaneously dispensed with the first roll of tape 50 on the first spool 30. As stated above, the first and second rolls of tape 50, 60 are oriented so that their adhesive surfaces 52, 62, respectively face in the opposite directions. The third roll of tape 65 is oriented with its adhesive surface 67 in the same direction as the adhesive surface 52 on the first roll of tape 50 and opposite the adhesive surface on the second roll of tape 60. In the second embodiment, the third spool 44 is offset from the second spool 40 so that the unwound section of tape 66 from the third roll 65 is parallel and slightly offset from the unwound section 61 on the second roll of tape 60. The overlapping sections of the adjacent adhesives surfaces on the two rolls are adhesively attached together.

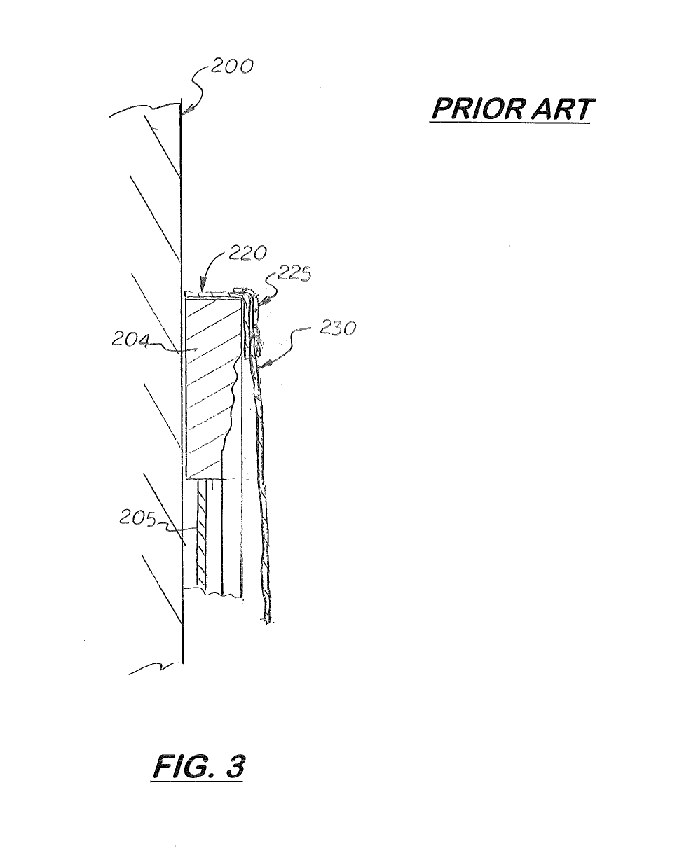

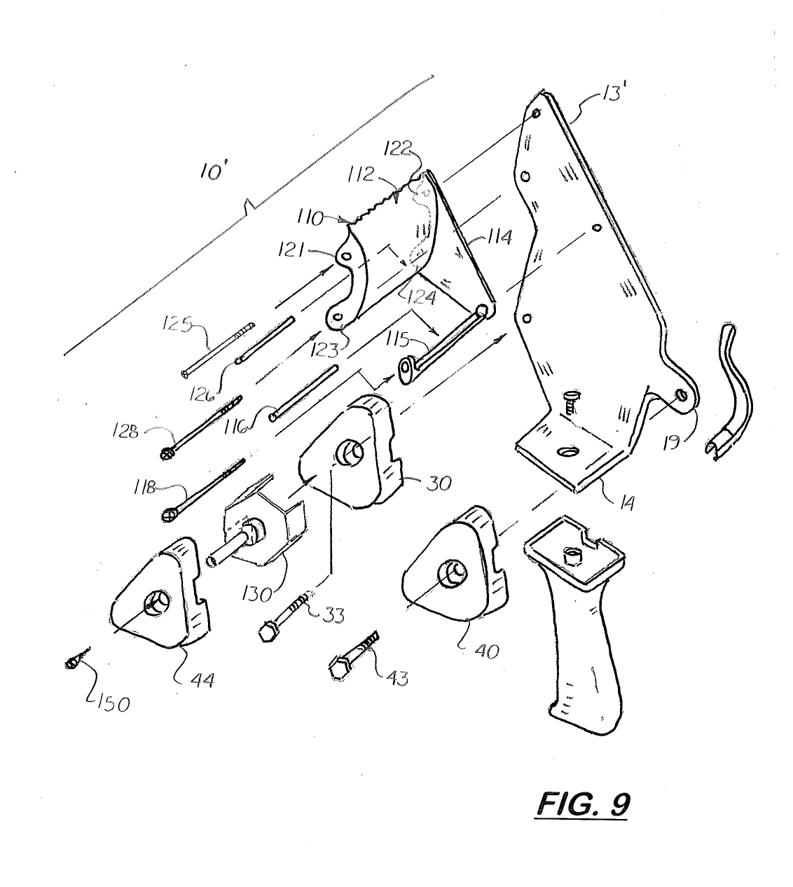

FIG. 9 is an exploded perspective view of the second embodiment of the hand tool 10′. The hand tool 10′ is the left hand version of the right hand version of the hand tool 10 shown in FIGS. 3-7. The hand tool 10′ includes a flat support plate 12′ with a perpendicularly handle support plate 14. A handle 20 is attached to the hand support plate 14 and an optional belt clip 22 may be attached to the back surface of the support plate 12′. The first spool 30 is attached via a threaded bolt 33 to a threaded hole located near the support plate's midline horizontal axis. Integrally formed or attached to the edge of the support plate opposite the first spool 30 is the straight extension arm 19. The second spool 40 is attached via a threaded bolt 43 to a threaded hole formed on the extension arm 19.

FIG. 9 also shows a cutting blade assembly 110 located above the first spool 30. The cutting blade assembly 110 includes a cup shaped body 112 with a serrated edge. The inside edge of the cup shaped body 112 is attached to an attachment plate 114 that extends over the outside surface of the support plate 13′. The attachment plate 114 includes a perpendicularly aligned elongated guide 115 in which an elongated bushing 116 is placed. A threaded bolt 118 is inserted into the guide 115 and into the bushing 116 to hold the bushing 116 in place. The end of the bolt 118 engages a threaded hole formed on the support plate 13′. During use, the elongated guide 115, the bushing 116, and the bolt 118 acts and serves as the alignment rod 70 shown on the first embodiment of the hand tool 10.

The cup shaped body 112 also include two upper parallel guide arms 121, 123 and two lower parallel guide arms 122, 124. Disposed between the upper parallel guide arms 121, 123 is a threaded bolt 125 that engages a threaded hole formed on the upper end of the support plate 13′. Disposed between the lower parallel guide arms 123, 124 is an elongated bushing 126. During assembly, a threaded bolt 128 is inserted into the guide arms 123, 124 and into the bushing 126 to hold the arms 123, 124 and the bushing 126 in place. The end of the bolt 128 engages a threaded hole formed on the support plate 13′. During use, the two guide arms 123, 124, the bushing 126 and the bolt 128 together acts and serves as the tensioning rod 80 used in the first embodiment of the hand tool 10.

As also shown in FIG. 9, the spools 30, 40, 44 in second embodiment are triangular, cylindrical structures approximately 3 inches in diameter and approximately 1-½ inches in length. The first and second spool 30, 40 includes a recessed center cavity designed to hold the head of the threaded bolts 33, 43 The bolts 33, 43 acts as axles for the two spools 30, 40, respectively. As stated above, the threaded bolts extends through the spools 30, 40 and connect to treaded holes formed on the support plate 12′. The third spool 44 also includes a recessed center cavity designed to hold the head of a thread screw 150 that engages the threaded hole on the distal end of a post 138 attached to the intermediate coupler 130.

The second embodiment of the hand tool 10′ may be used only with the first and second spools 30, 40 similar to the first embodiment of the hand tool 10, shown in FIGS. 4-7. With the second embodiment, the user may attach the third spool 44 with a third roll of tape 65 mounted thereon.

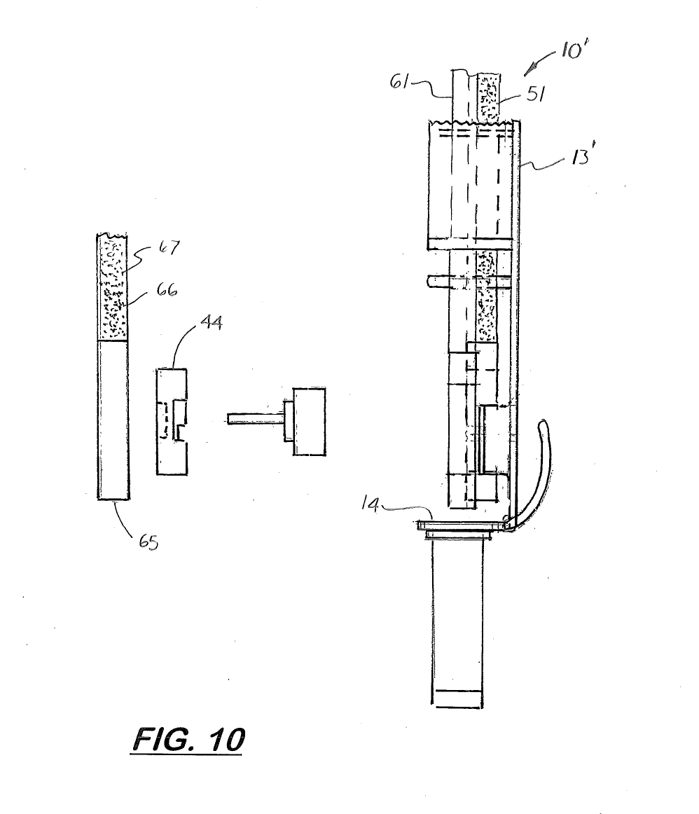

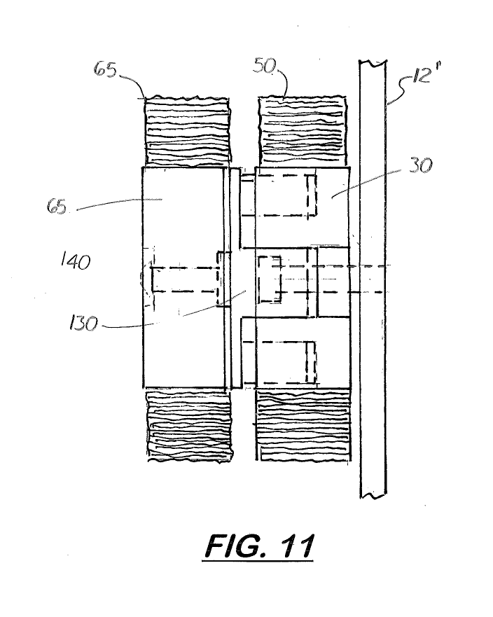

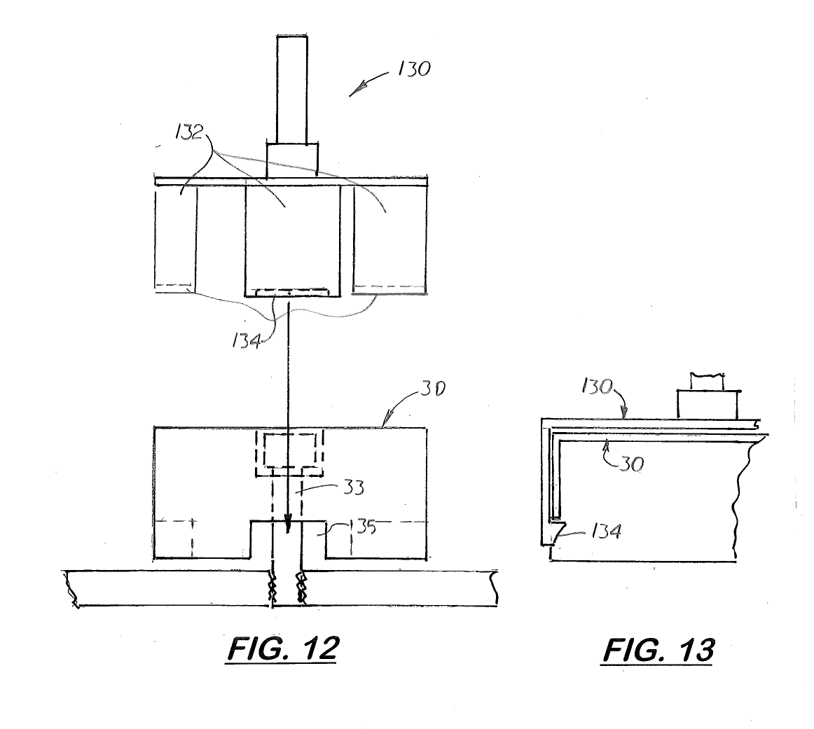

FIG. 10 is right side elevational view of the hand tool 10′ showing the third roll of tape 65 being aligned over the third spool 44. The third spool 44 is coaxially aligned over an intermediate coupler 130 that attaches to the first spool 30. When assembled, the first spool 30 and third spool 44 are spaced so that a ¼ to 1 inch gap 150 is formed between their adjacent edges. Disposed in the gap 150 is the adhesive surface the unwound section of tape 51 from the second roll of tape 50 mounted on the second spool 40.

The coupler 130 includes a circular plate 131 with three downward extending side arms 132 attached thereto that during assembly, snap fit over the outside surface of the first spool 30. Extending upward from the circular plate 131 is a post 138. Formed on the lower edge of the first spool 30′ are three slots 135. Formed on the lower edge of each arm 132 is an inward extended beveled lip 134 that snap fits into the spool's slot to hold the coupler 130 over the first spool 30′.

When assembled, the third spool 44 is extends outside the second spool 40 so that the third roll of tape 65 partially overlaps the laterally edge of the unwound section 61 of the second roll of tape 60 opposite the unwound section 51 of tape from the first roll 50. The third roll of tape 65 is positioned so that a portion of the unwound section 61 of the second roll of tape 60 is continuously exposed. The second embodiment hand tool 10′ is particularly useful when a single strip of unwound section 51 of the first roll of tape 50 is insufficient to hold a large sheet 230 to a flat surface. Using a third roll of tape 65 provides more adhesive surface contact also holds the opposite edge of the unwound second 61 of the second roll of tape 60 in place. Typically, the second embodiment is useful when the wall surface is exposed to moisture, has a rough texture, or when a heavier large sheet is used.

During operation, the user can use different widths of tape on each spool to change the width of the exposed adhesive surfaces of the tapes attached to the wall surface or attached to the cover 230. Also on the second embodiment, the user may use different width of the third roll of tape to control the amount of additional adhesive force is needed to hold the cover onto the wall surface.

Using the above described hand tool 10, a method of easily and quickly masking a large surface 230 is disclosed. After assembly, the hand tool 10 is held so that the support plate 12 is parallel to the desired flat surface. The adhesive surface 52 on the end of the unwound section of tape 51 on the first roll 50 is pressed against the desired location on the w flat surface. When the hand tool 10′ is pulled across the flat surface, the two unwound sections of tape 51, 61 from the first and second rolls 50, 60, respectively, are simultaneously pulled over the rotating alignment rod 80 and rotating tensioning rod 90. When the adhesive surface 52 on the first roll 50 is forced against the desired flat surface, sufficient dragging pressure is applied to the hand tool 10 so that unwound sections 51, 61 of tape 50, 60, respectively are under tension and taunt. Because the two unwound sections of tape 51, 61 are first aligned and pressed together over the alignment rod 80, the two unwound sections are attached together and remain parallel and evenly and uniformly aligned at all times. When the desired amount of unwound sections of tape 51, 61 from the two rolls 50, 60, respectively, have been applied to the flat surface, hand tool 10 is then repositioned so that the cutting edge may be forced against the unwound sections 51, 61 and cut them.

After the two sections of tape from the first and second rolls 50, 60 have been cut to size and applied to the flat surface, the adhesive surface on the unwound section of tape from the second roll 60 is exposed. A large, lightweight sheet 230 of masking paper or plastic is then applied to the exposed adhesive surface on the unwound section of tape 61 from the second roll 60. The large sheet 230 is then unfolded and extended across the entire large area.

The second embodiment of the hand tool 10′ is used in the same manner and used with additional adhesive surface is needed.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A hand tool used to mask and cover a surface to be protected when painting, comprising:
a. a rigid support plate;
b. two parallel first and second spools and perpendicularly mounted on said support plate, said spool being configured on said support plate so that said spools are offset at different distances from said support plate so that said first spool is disposed closer to said support plate;
c. a first roll of masking tape attached to said first spool, said first roll includes a non-adhesive side and an adhesive surface;
d. a second roll of masking tape attached to said second spool, said second roll includes a non-adhesive surface and an adhesive surface, said second roll of masking tape being configured on said second spool so when said second roll of masking tape is unwound when attached to said second spool, said adhesive surface on the unwound section is oriented in a direction opposite said adhesive surface on the unwound section of said first roll of masking tape mounted on said first spool;
e. a rotating alignment rod attached to said support plate and located above and parallel to said first spool and said second spool;
f. a rotating tensioning rod attached to said support plate and located above and parallel to said first spool and said second spool;
g. a cutting edge attached to said support plate; and,
h. whereby when said first and second rolls of masking tape are aligned on said first spool and said second spool and partially unwound and extended around said alignment rod, the unwound sections of said first roll of tape and said second roll of tape partially overlap and adhere together and with the non-lapping sections of adhesive surface on said first roll being exposed and pressed against a surface to be masked, and the exposed adhesive surface on said second roll of tape also exposed and oriented in the opposite direction and attached to masking sheet.

2. The hand tool, as recited in claim 1, further including a handle attached to said support plate.

3. The hand tool, as recited in claim 1, further including a belt clip attached to said support plate.

4. The hand tool, as recited in claim 1, wherein said support plate includes a means for disposing said first spool and aid second spool in offset positions from said support plate.

5. The hand tool, as recited in claim 1, further including a third spool spaced apart and coaxially aligned with said first stool, said third spool includes a third roll of masking tape mounted thereon, said third roll of masking tape including an adhesive surface, said third roll of masking tape being oriented on said third spools so that said adhesive surface faces the same direction as said adhesive surface on said first roll of masking tape, said third spool and said first spool being sufficiently spaced apart to create a gap for a section of adhesive surface of said second roll of tape.

6. A hand tool for simultaneously at least two strips with their adhesive surfaces disposed in opposite directions and partially overlapping, said hand tool comprises:
a. a support plate;
b. a first and second spool perpendicularly mounted on said support plate, said spool being configured on said support plate so that rolls of tape mounted on said spools are partially offset and the adhesive surface on unwound section of tape from said rolls of spools are partially overlap and joined together;
c. a rotating alignment rod attached to said support plate and located above and parallel to said first spool and said second spool;
d. a rotating tensioning rod attached to said support plate and located above and parallel to said first spool and said second spool; and,
e. a cutting edge attached to said support plate; and,

7. The hand tool, as recited in claim 6, further including a third spool spaced apart and coaxially aligned over said first stool, said third spool includes a third roll of masking tape mounted thereon, said third roll of masking tape including an adhesive surface that faces the same direction as said adhesive surface on said first roll of masking tape, said third spool and said first spool being sufficiently spaced apart to create a gap for a section of adhesive surface of said second roll of tape to be exposed.
